(19) United States
(12) Patent Application Publication
(10) Pub. No.: US 2006/0163000 A1
(43) Pub. Date: Jul. 27, 2006

(54) Personal fire escape system

(76) Inventor: Roy Chowthi, Norristown, PA (US)

Correspondence Address: ROY CHOWTHI, 2nd FLOOR, 269 AVENUE B, BAYONNE, NJ, 07002, US

(21) Appl. No.: 11/041,108

(22) Filed: Jan. 24, 2005

(51) Int. Cl. A62B 1/06

(52) U.S. Cl. 182/72

(57) ABSTRACT

Personal fire escape systems allow a user to escape fires in buildings. A covered enclosure is bolted to a window and stores a spool housing when it is not in use. The spool housing encloses a spool with a cable wound around it. One end of the cable protrudes from the top of the spool housing and is attached to the building. A pair of wrist straps is attached to the sidewall of the spool housing and has wrist loops for securing the wrist straps to the user's wrist. A brake is biased towards preventing the spool from rotating by springs. The user depresses a brake lever towards a handle to pull a brake rod to release the brake to control their rate of descent.

### BACKGROUND OF THE INVENTION

1. Field of the Invention

The present invention relates to a personal fire escape system for use in connection with high-rise buildings. The personal fire escape system has particular utility in connection with escaping fires in buildings.

2. Description of the Prior Art

Personal fire escape systems are desirable for escaping fires in buildings. Many persons are killed or injured in fires in buildings because they are unable to escape. This problem especially exists in high-rise buildings, where jumping out a window is often perilous at best. Personal fire escape systems provide a convenient and readily accessible means of egress from a building through a window by providing a controlled descent.

The use of rappel rescue systems is known in the prior art. For example, U.S. Pat. No. 4,714,135 to Bell et al. discloses a rappel rescue system. However, the Bell et al. '135 patent does not have calipers, and has further drawbacks of lacking a spool.

U.S. Pat. No. 4,499,966 to Milne et al. discloses an emergency escape system that slowly lowers the user to safety. However, the Milne et al. '966 patent does not have a spool, and additionally does not function without the installation of a track on the side of the building to be escaped from.

Similarly, United States Patent Application Publication 2003/0051944 to Shea discloses a descent control device that controls a user's rate of descent down a rope. However, the Shea 2003/0051944 patent application publication does not have a spool, and does not have a brake lever.

In addition, U.S. Pat. No. 3,760,901 to Hynes discloses a lifesaving systems for escaping from high buildings in the case of fires or other emergencies that allows a user to escape from high buildings in case of fires or other emergencies. However, the Hynes '901 patent does not have a handle, and also does not allow the user to control their speed of descent while descending.

Furthermore, U.S. Pat. No. 5,010,850 to Sailer discloses a seat and harness device that can be used as a swing type seat and as a harness to assist the wearer in towing materials. However, the Sailer '850 patent does not have a spool, and further lacks a brake.

U.S. Pat. No. 3,978,942 to Jimenez discloses a portable window-attached emergency descent mechanism that allows the use of a conventional window as an avenue of escape in emergency situations such as fires. However, the Jimenez '942 patent does not have an enclosure, and has the additional deficiency of not applying the brake when the portable descent mechanism is not in use.

In addition, U.S. Pat. No. Des. 363,784 to Lund discloses a combined window and fire escape that allows a user to escape a fire through a window. However, the Lund '784 patent does not have a brake, and also does not have a spool.

Lastly, U.S. Pat. No. 4,520,900 to Orgeron discloses a fire escape apparatus for use in high-rise buildings and the like that is a personal escape mechanism for emergency evacuation of a high-rise building. However, the Orgeron '900 patent does not allow the user to control their speed of descent while descending, and further lacks the ability to function without an I-beam projecting out of the building to be escaped from.

While the above-described devices fulfill their respective, particular objectives and requirements, the aforementioned patents do not describe a personal fire escape system that allows escaping fires in buildings. The Bell et al. '135 patent makes no provision for calipers. The Bell et al. '135 patent, the Milne et al. '966 patent, the Shea 2003/0051944 patent application publication, the Sailer '850 patent, and the Lund '784 patent do not have a spool. The Milne et al. '966 patent cannot function unless a track has been installed on the side of the building to be escaped from. The Shea 2003/0051944 patent application publication lacks a brake lever. The Hynes '901 patent does not have lever. The Hynes '901 patent and the Orgeron '900 patent do not allow the user to control their speed of descent while descending. The Sailer '850 patent and the Lund '784 patent omit a brake. The Jimenez '942 patent lacks an enclosure. The Jimenez '942 patent does not apply the brake when the portable descent mechanism is not in use. The Orgeron '900 patent cannot function without an I-beam projecting out of the building to be escaped from.

Therefore, a need exists for a new and improved personal fire escape system that can be used for escaping fires in buildings. In this regard, the present invention substantially fulfills this need. In this respect, the personal fire escape system according to the present invention substantially departs from the conventional concepts and designs of the prior art, and in doing so provides an apparatus primarily developed for the purpose of escaping fires in buildings.

### SUMMARY OF THE INVENTION

In view of the foregoing disadvantages inherent in the known types of rappel rescue systems now present in the prior art, the present invention provides an improved personal fire escape system, and overcomes the above-mentioned disadvantages and drawbacks of the prior art. As such, the general purpose of the present invention, which will be described subsequently in greater detail, is to provide a new and improved personal fire escape system which has all the advantages of the prior art mentioned heretofore and many novel features that result in a personal fire escape system which is not anticipated, rendered obvious, suggested, or even implied by the prior art, either alone or in any combination thereof.

To attain this, the present invention essentially comprises a hollow enclosure having a plurality of wall mounts attached to its opposing ends and a window mount attached to one of its sides. A plurality of screws have one end inserted through one of the wall mounts or the window mount. An enclosure hook has one end attached to one of the ends of the enclosure. A housing hook has one end removably connected to the opposing end of the enclosure hook. A hollow spool housing has its top connected to the opposing end of the housing hook. A cable has one end protruding from the top of the spool housing. A pulley is connected to the cable. A spool is attached to the cable's opposing end. An axle has the spool mounted on its middle. A brake is releasably frictionally engaged with the spool, wherein the brake can be adjusted to vary the speed of descent by a user while descending. A handle is attached to the bottom of the spool housing. A brake lever has one end pivotably attached to the bottom of the spool housing. A brake rod has one end connected to the brake and its opposing end attached to the end of the brake lever.

There has thus been outlined, rather broadly, the more important features of the invention in order that the detailed description thereof that follows may be better understood and in order that the present contribution to the art may be better appreciated.

The invention may also include a hinge attached to one of the enclosure's ends, a cover attached to the hinge and removably covering the enclosure, a latch receiver attached to the cover, and a latch with one end removably inserted into the latch receiver and its opposing end attached to one of the ends of the enclosure. There may be a wrist strap with one end attached to the sidewall of the spool housing and a wrist loop attached to the wrist strap's opposing end. There may be a bolt receiver with one end attached to the rear of the spool housing, a spool housing cover attached to the front of the spool housing, a bolt hole in the spool housing, a spring post hole in the spool housing, a plurality of brake cylinder grooves in the spool housing cover and the rear of the spool housing, and a bolt with one end inserted through the bolt hole and threadedly inserted into the bolt receiver. The brake may comprise a brake cylinder inserted into the brake cylinder grooves in the spool housing cover and the spool housing, a brake loop attaching one end of the brake cylinder to the brake rod, a brake plate groove in the middle of the brake cylinder, a brake plate inserted into the brake plate groove, a spring post hole in the brake plate, a bolt hole in the brake plate, an axle hole in the brake plate, a spool groove in the brake plate, a spring post with one end inserted through the spring post hole in the brake plate and the spool housing cover, a brake pad attached to the opposing end of the spring post, a spring encircling the spring post between the brake plate and the brake pad, and a spring encircling the spring post between the brake plate and the spool housing cover. The enclosure may be about 8 inches high, 8 inches wide, and 2 inches deep. The cover, the enclosure, and the spool housing may be selected from the group consisting of plastic, steel, aluminum, titanium, wood, and carbon fiber composite. The wrist strap may be made of nylon. The springs may urge the brake plate and the brake pad against the spool when the brake lever is not depressed toward the spool housing. There may be a plurality of wrist straps. There may be a plurality of wrist loops. The wrist straps may be attached to the spool housing by screws. The invention may be an improvement to a building. The cable may have one end attached to the building. There may be a plurality of brake pads, each being attached to the opposing end of two of the spring posts. There are, of course, additional features of the invention that will be described hereinafter and which will form the subject matter of the claims attached.

Numerous objects, features, and advantages of the present invention will be readily apparent to those of ordinary skill in the art upon a reading of the following detailed description of presently current, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved personal fire escape system that has all of the advantages of the prior art rappel rescue systems and none of the disadvantages.

It is another object of the present invention to provide a new and improved personal fire escape system that may be easily and efficiently manufactured and marketed.

An even further object of the present invention is to provide a new and improved personal fire escape system that has a low cost of manufacture with regard to both materials and labor, and which accordingly is then susceptible of low prices of sale to the consuming public, thereby making such personal fire escape system economically available to the buying public.

Still another object of the present invention is to provide a new personal fire escape system that provides in the apparatuses and methods of the prior art some of the advantages thereof, while simultaneously overcoming some of the disadvantages normally associated therewith.

Even still another object of the present invention is to provide a personal fire escape system for escaping fires in buildings. This allows a user to rapidly escape a building from its upper floors.

Still yet another object of the present invention is to provide a personal fire escape system for escaping fires in buildings. This makes it possible to easily access the personal fire escape system.

An additional object of the present invention is to provide a personal fire escape system for escaping fires in buildings. This makes the personal fire escape system unobtrusive.

A further object of the present invention is to provide a personal fire escape system for escaping fires in buildings. This makes the personal fire escape system easy to use.

Lastly, it is an object of the present invention to provide a new and improved personal fire escape system for escaping fires in buildings.

These together with other objects of the invention, along with the various features of novelty that characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there is illustrated current embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a top perspective view of the current embodiment of the personal fire escape system constructed in accordance with the principles of the present invention.

FIG. 2 is a top perspective view of the personal fire escape system of the present invention.

FIG. 3a is a top perspective exploded view of the personal fire escape system of the present invention.

FIG. 3b is a top perspective exploded view of the personal fire escape system of the present invention.

FIG. 4 is a front side view of the personal fire escape system of the present invention.

FIG. 5 is a rear side view of the personal fire escape system of the present invention.

FIG. 6 is a side sectional fragmentary view of the spool housing of the present invention.

The same reference numerals refer to the same parts throughout the various figures.

### DESCRIPTION OF THE CURRENT EMBODIMENT

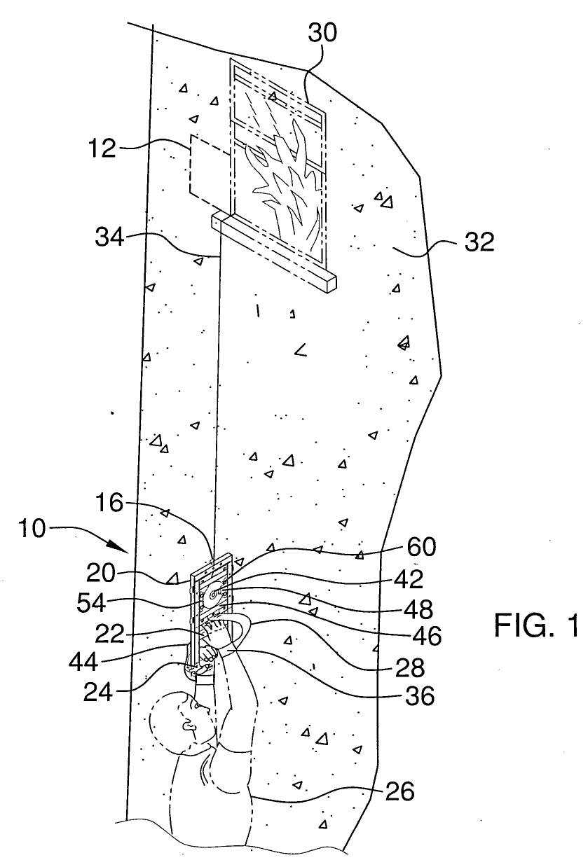

Referring now to the drawings, and particularly to FIGS. 1-6, a current embodiment of the personal fire escape system of the present invention is shown and generally designated by the reference numeral 10.

In FIG. 1, a new and improved personal fire escape system 10 of the present invention for escaping fires in buildings is illustrated and will be described. More particularly, the personal fire escape system 10 has an enclosure 12 that is attached to the window 30 of a building 32. A cable 34 has one end connected to the window 30 and its opposing end connected to a spool 42. The personal fire escape system 10 is shown in use with a user 26 grasping handles 22 that are attached to the bottom of a spool housing 20 that has a spool housing cover 54. Wrist straps 28 with wrist loops 36 further secure the user 26 to the spool housing 20, and prevent the user 26 from falling in the event he or she loses their grip on the handles 22. The user depresses the brake lever 24 to control their speed of descent as the cable 34 is paid out from the spool housing 20. Brake rod 44, brake cylinders 46, spring posts 60, and springs 48 permit the user to control their speed of descent using brake lever 24 and will be described in more detail subsequently. Note that the user 26, window 30, and building 32 are for illustrative purposes only and are not part of the current invention.

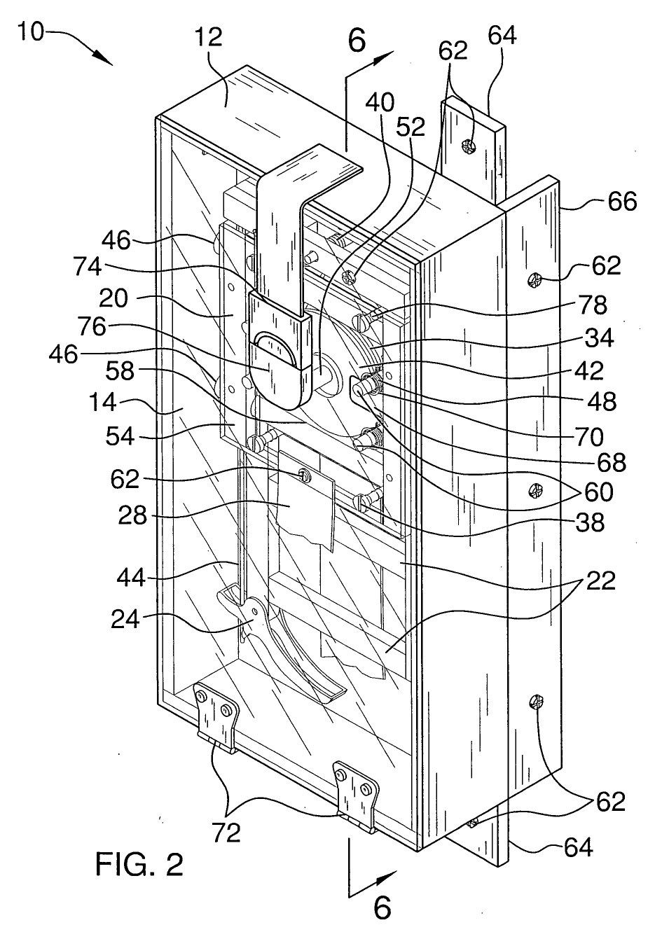

Moving on to FIG. 2, a new and improved personal fire escape system 10 of the present invention for escaping fires in buildings is illustrated and will be described. More particularly, the personal fire escape system 10 is stored in enclosure 12 when it is not in use. Screws 62 inserted through wall mounts 64 and window mount 66 attach the enclosure 12 beside window 30 (not shown) of building 32 (not shown). Cover 14 is hingedly attached by hinges 72 to enclosure 12 and is releasably held in place by latch 74 inserted into latch receiver 76 attached to cover 14. Spool housing 20 has a spool housing cover 54 attached by bolts 38 threadedly inserted into bolt receivers 78. Spool 42 is mounted on axle 52 and has a spool lock 70 that is inserted into a spool groove 68 in brake plate 58 when the personal fire escape system 10 is not in use. When the spool lock 70 is inserted into the spool groove 68, spool 42 is prevented from spinning. Cable 34 is wound around spool 42 and passes over pulley 40 when the personal fire escape system 10 is in use. Springs 48 are mounted on spring posts 60 to push brake plate 58 against spool 42. Brake cylinders 46 also serve to push brake plate 58 against spool 42. Brake rod 44 connects brake lever 24 to the brake cylinders 46. Handles 22 and a portion of wrist straps 28, which are attached to the spool housing 20 by screws 62, are also visible. The brake lever 24 is pivotably connected to the spool housing 20 so that it can be depressed towards the handle 22 so that the user 26 can control their speed of descent as the cable 34 is paid out from the spool housing 20.

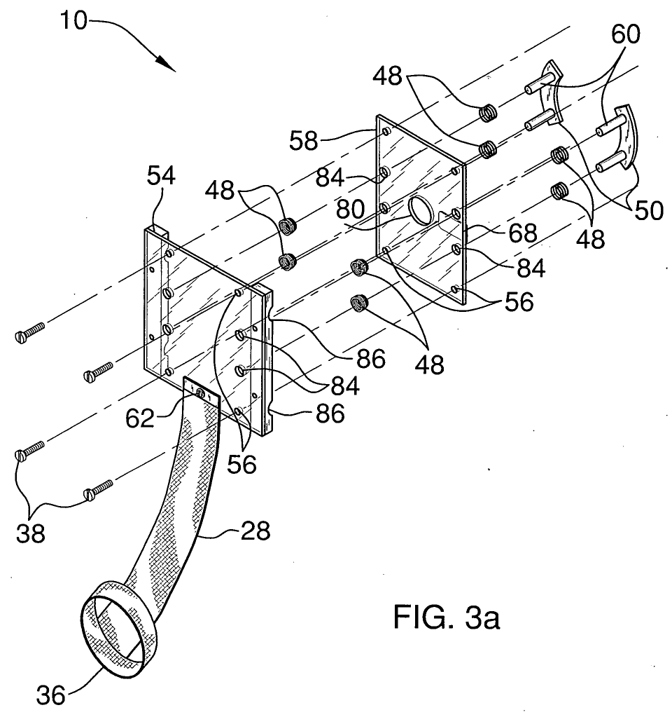

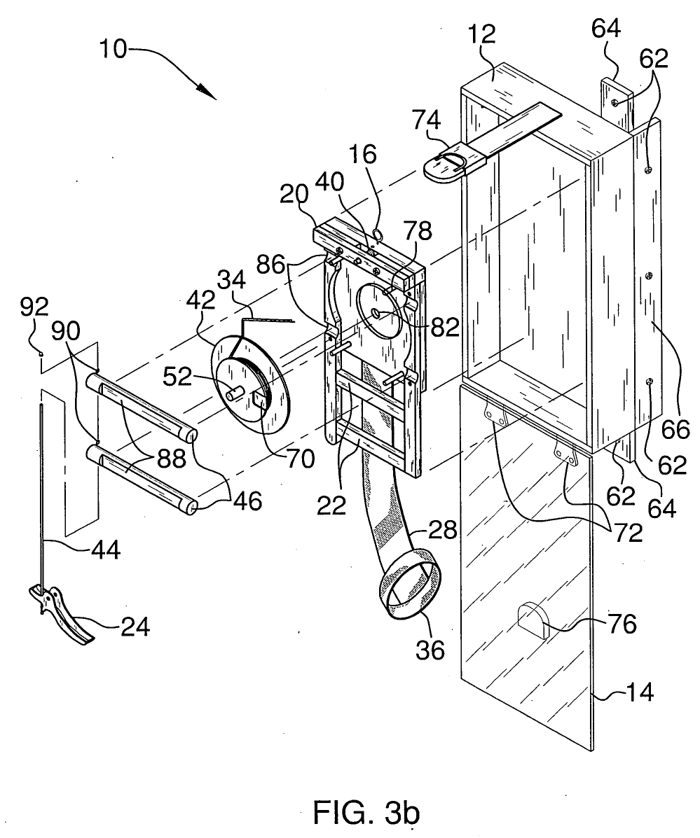

Continuing with FIG. 3a, a new and improved personal fire escape system 10 of the present invention for escaping fires in buildings is illustrated and will be described. More particularly, the personal fire escape system 10 has a spool housing cover 54 with spring post holes 84 and bolt holes 56 in it. One end of a wrist strap 28 is attached by screw 62 to the spool housing cover 54. The opposing end of the wrist strap 28 ends in a wrist loop 36. A brake plate 58 is mounted beneath the spool housing cover 54 and also has bolt holes 56 and spring post holes 84 in it. Brake plate 58 also has a spool groove 68 in it to receive spool lock 70 (not shown) and an axle hole 80 to receive axle 52 (not shown). Brake pads 50 have spring posts 60 protruding from them that receive springs 48. Brake plate 58 is then mounted on the spring posts 60, followed by an additional set of springs 48. Finally, spool housing cover 54 is mounted on spring posts 60 and bolts 38 are inserted through bolt holes 56, where they mate with bolt receiver 78 (not shown). Spool housing cover 54 also has brake cylinder grooves 84 in it to receive brake cylinders 46 (not shown). The springs 48 allow brake plate 58 to urge brake pads 50 against spool 42 to control its speed of rotation. The springs 48 also urge brake plate 58 against spool 42 to control its speed of rotation.

Continuing with FIG. 3b, a new and improved personal fire escape system 10 of the present invention for escaping fires in buildings is illustrated and will be described. More particularly, the personal fire escape system 10 has a brake lever 24 connected to one end of a brake rod 44. The opposing end of the brake rod 44 is inserted through brake loops 90 attached to one end of brake cylinders 46 and terminates in an end cap 92. The brake cylinders 46 have brake plate grooves 88 in them to receive brake plate 58 (not shown). Spool 42 is rotatably mounted on axle 52 and has a spool lock 70 protruding from it. Axle 52 is inserted through rear axle hole 82 in the rear of the spool housing 20. Bolt receivers 78 protrude from the spool housing 20. Pulley 40 and housing hook 16 are attached to the top of the spool housing 20. The spool housing 20 also has brake cylinder grooves 86 in it to receive brake cylinders 46. Handles 22 are attached to the bottom of the spool housing 20, along with a wrist strap 28 that terminates in a wrist loop 36. The enclosure 12 is shown with its cover 14 in its open position and latch 74 disconnected from latch receiver 76. Screws 62 are inserted through wall mount 64 and window mount 66. Cable 34 has one end wound around spool 42.

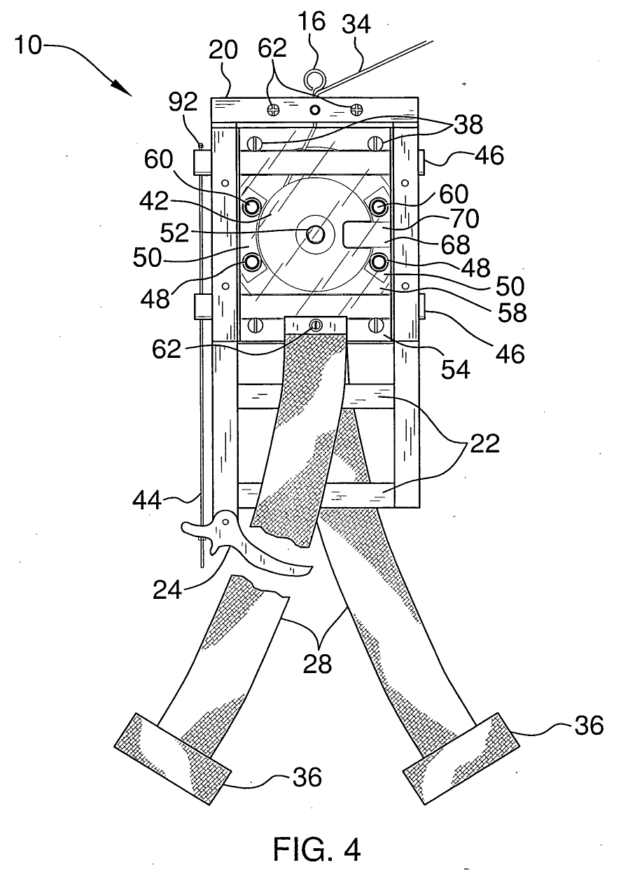

In FIG. 4, a new and improved personal fire escape system 10 of the present invention for escaping fires in buildings is illustrated and will be described. More particularly, the personal fire escape system 10 has a spool housing 20 that encloses a spool 42 that is attached to one end of a cable 34. Spool housing 20 is assembled using screws 62 and bolts 38. Brake rod 44 connects the brake lever 24 to the brake cylinders 46 and terminates in end cap 92. Handles 22 and wrist straps 28 with wrist loops 36 are attached to the bottom of the spool housing 20. A spool housing cover 54 covers brake plate 58. When not in use, the spool lock 70 attached to spool 42 is inserted into spool groove 68 in the brake plate 58 to prevent spool 42 from rotating. Brake cylinders 46 urge brake plate 58 against spool 42, and brake plate 58 in turn urges brake pads 50 against spool 42. Brake plate 58 is mounted on springs 48 encircling spring posts 60.

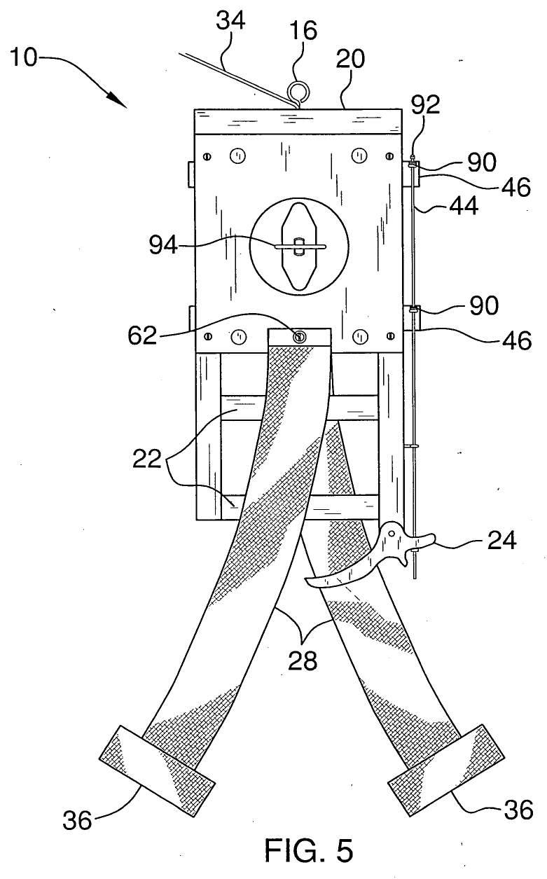

Furthermore, in FIG. 5, a new and improved personal fire escape system 10 of the present invention for escaping fires in buildings is illustrated and will be described. More particularly, the personal fire escape system 10 has a spool housing 20 with a housing hook 16 attached to its top and handles 22 and wrist straps 28 terminating in wrist loops 36 attached to its bottom. Brake rod 44 is attached to brake cylinders 46 by brake loops 90, has an end cap 92 at one end, and has a brake lever 24 attached to its opposing end. An axle handle 94 protrudes from the rear of the spool housing 20 and is connected to the axle 52 so that cable 34 can be rewound about spool 42 after the personal fire escape system 10 has been used.

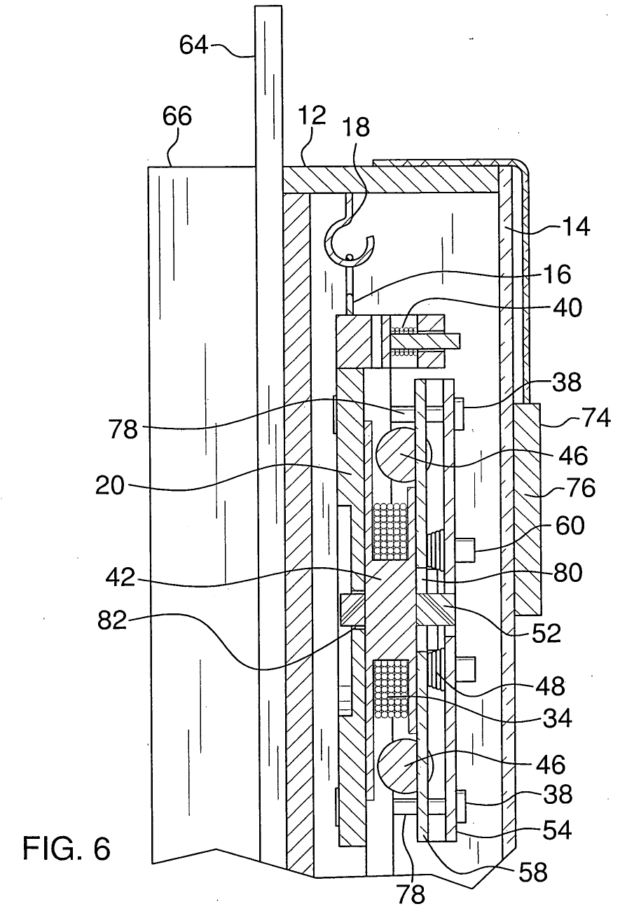

Concluding with FIG. 6, a new and improved spool housing 20 of the present invention for escaping fires in buildings is illustrated and will be described. More particularly, the spool housing 20 has a housing hook 16 that is hung on enclosure hook 18 when the personal fire escape system 10 is not in use. The enclosure 12 protects the personal fire escape system 10 from damage and has a cover 14 that is releasably secured to the enclosure 12 by latch 74 inserted into latch receiver 76 attached to cover 14. Pulley 40 is attached to the top of the spool housing 20. Springs 48 encircling spring posts 60 urge brake plate 58 against spool 42. Axle 52 protrudes through axle hole 80 and rear axle hole 82. Bolt receiver 78 receives bolts 38. Brake cylinders 46 act to lift brake plate 58 when brake lever 24 (not shown) is depressed, thereby freeing spool 42 to rotate and pay out cable 34. Wall mount 64 and window mount 66 are also illustrated.

In use, it can now be understood that in the event of a fire or other emergency preventing the use of normal forms of egress, the user opens the cover of the enclosure 12 by releasing the latch from the latch receiver and uses the wrist loops to fasten the wrist straps to his or her wrists. The user then lowers himself or herself from the window by grasping the handles and depressing the brake lever to rotate the brake cylinders in a clockwise direction. By rotating in a clockwise direction, the brake cylinders raise the brake plate. This releases the pressure on the spool from the brake plate and brake pads. The spool lock also disengages from the spool groove. The user's weight places the cable in tension and causes the spool to spin and pay out cable through the top of the spool housing across the pulley. The more the user squeezes the brake lever, the faster he or she will descend. In the event he or she desires to stop descending, the user can release the brake lever, which causes the brake cylinders to rotate in a counterclockwise direction and returns the brake plate to the brake plate grooves. The brake plate and brake pads then strongly frictionally engage with the spool, preventing it from spinning and paying out additional cable. Upon reaching the ground, the user releases the handles and detaches the wrist straps from his or her wrists.

While a current embodiment of the personal fire escape system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as plastic, aluminum, titanium, wood, or carbon fiber composite may be used instead of the steel cover, enclosure, and spool housing described. Also, the nylon wrist straps may also be made of other appropriate materials. And although escaping fires in buildings has been described, it should be appreciated that the personal fire escape system herein described is also suitable for escaping buildings under a wide range of circumstances. Furthermore, a wide variety of braking systems may be used instead of the braking system described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A personal fire escape system comprising:
a hollow enclosure having opposing sides and opposing ends;
a plurality of wall mounts attached to said opposing ends of said enclosure;
a window mount attached to one of said sides of said enclosure;
a plurality of screws having opposing ends with one end inserted through one of said wall mounts or said window mount;
an enclosure hook having opposing ends with one end attached to one of said ends of said enclosure;
a housing hook having opposing ends with one end removably connected to said opposing end of said enclosure hook;
a hollow spool housing having a front, a rear, a bottom, and a top with said top connected to said opposing end of said housing hook;
a cable having opposing ends with one end protruding from said top of said spool housing;
a pulley connected to said cable;
a spool attached to said opposing end of said cable;
an axle having opposing ends and a middle, wherein said spool is mounted on said middle of said axle;
a brake releasably frictionally engaged with said spool, wherein said brake can be adjusted to vary the speed of descent by a user while descending;
a handle attached to said bottom of said spool housing;
a brake lever having opposing ends with one end pivotably attached to said bottom of said spool housing; and
a brake rod having opposing ends with one end connected to said brake and said opposing end attached to said end of said brake lever.

2. The personal fire escape system as defined in claim 1, further comprising:
a hinge attached to one of said ends of said enclosure;
a cover attached to said hinge and removably covering said enclosure;
a latch receiver attached to said cover; and
a latch having opposing ends with one end removably inserted into said latch receiver and said opposing end attached to one of said ends of said enclosure.

3. The personal fire escape system as defined in claim 1, further comprising:
a wrist strap having opposing ends with one end attached to said sidewall of said spool housing; and
a wrist loop attached to said opposing end of said wrist strap.

4. The personal fire escape system as defined in claim 1, further comprising:
a bolt receiver having opposing ends with one end attached to said rear of said spool housing;
a spool housing cover attached to said front of said spool housing;
a bolt hole, wherein said spool housing defines a hole therein to comprise said bolt hole;
a spring post hole, wherein said spool housing cover defines a hole therein to comprise said spring post hole;
a plurality of brake cylinder grooves, wherein said spool housing cover and said rear of said spool housing define grooves therein to comprise said brake cylinder grooves; and
a bolt having opposing ends with one end inserted through said bolt hole and threadedly inserted into said bolt receiver.

5. The personal fire escape system as defined in claim 4, wherein said brake comprises:
a brake cylinder having opposing ends and a middle inserted into said brake cylinder grooves in said spool housing cover and said spool housing;
a brake loop attaching one end of said brake cylinder to said brake rod;
a brake plate groove, wherein said middle of said brake cylinder defines a groove therein to comprise said brake plate groove;
a brake plate inserted into said brake plate groove;
a spring post hole, wherein said brake plate defines a hole therein to comprise said spring post hole;
a bolt hole, wherein said brake plate defines a hole therein to comprise said bolt hole;
an axle hole, wherein said brake plate defines a hole therein to comprise said axle hole;
a spool groove, wherein said brake plate defines a groove therein to comprise said spool groove;
a spring post having opposing ends with one end inserted through said spring post holes in said brake plate and said spool housing cover;
a brake pad attached to said opposing end of said spring post;
a spring encircling said spring post between said brake plate and said brake pad; and
a spring encircling said spring post between said brake plate and said spool housing cover.

6. The personal fire escape system as defined in claim 1, wherein said enclosure is about 8 inches high, 8 inches wide, and 2 inches deep.

7. The personal fire escape system as defined in claim 2, wherein said cover, said enclosure, and said spool housing are selected from the group consisting of plastic, steel, aluminum, titanium, wood, and carbon fiber composite.

8. The personal fire escape system as defined in claim 3, wherein said wrist strap is made of nylon.

9. The personal fire escape system as defined in claim 5, wherein said springs urge said brake plate and said brake pad against said spool when said brake lever is not depressed toward said spool housing.

10. A personal fire escape system comprising:
a plurality of wrist straps having opposing ends;
a plurality of wrist loops attached to said end of said wrist straps;
a hollow spool housing having a top, a bottom, and a sidewall, wherein said opposing end of said wrist straps are attached to said sidewall;
a spool enclosed by said spool housing;
a cable having opposing ends with one end attached to said spool;
a housing hook having opposing ends with one end attached to said top of said spool housing;
an enclosure hook having opposing ends with one end removably connected to said opposing end of said housing hook;
a hollow enclosure having opposing sides and opposing ends with one end attached to said opposing end of said enclosure hook;
a plurality of wall mounts attached to said opposing ends of said enclosure;
a window mount attached to one of said sides of said enclosure;
a plurality of screws having opposing ends with one end inserted through one of said wall mounts or said window mount;
a pulley connected to said cable;
an axle having opposing ends and a middle, wherein said spool is mounted on said middle of said axle;
an axle handle attached to one of said opposing ends of said axle;
a brake releasably frictionally engaged with said spool, wherein said brake can be adjusted to vary the speed of descent by a user while descending;
a handle attached to said bottom of said spool housing;
a brake lever having opposing ends with one end pivotably attached to said bottom of said spool housing; and
a brake rod having opposing ends with one end connected to said brake and said opposing end attached to said end of said brake lever.

11. The personal fire escape system as defined in claim 10, further comprising a cover removably covering said enclosure.

12. The personal fire escape system as defined in claim 10, wherein said wrist straps are attached to said spool housing by screws.

13. The personal fire escape system as defined in claim 10, wherein said brake comprises:
a spool housing cover attached to said front of said spool housing;
a bolt hole, wherein said spool housing defines a hole therein to comprise said bolt hole;
a spring post hole, wherein said spool housing cover defines a hole therein to comprise said spring post hole;
a plurality of brake cylinder grooves, wherein said spool housing cover and said rear of said spool housing define grooves therein to comprise said brake cylinder grooves;
a brake cylinder having opposing ends and a middle inserted into said brake cylinder grooves in said spool housing cover and said spool housing;
a brake loop attaching one end of said brake cylinder to said brake rod;
a brake plate groove, wherein said middle of said brake cylinder defines a groove therein to comprise said brake plate groove;
a brake plate inserted into said brake plate groove;
a spring post hole, wherein said brake plate defines a hole therein to comprise said spring post hole;
a bolt hole, wherein said brake plate defines a hole therein to comprise said bolt hole;
an axle hole, wherein said brake plate defines a hole therein to comprise said axle hole;
a spool groove, wherein said brake plate defines a groove therein to comprise said spool groove;
a spring post having opposing ends with one end inserted through said spring post holes in said brake plate and said spool housing cover;
a brake pad attached to said opposing end of said spring post;
a spring encircling said spring post between said brake plate and said brake pad;
a spring encircling said spring post between said brake plate and said spool housing cover;
a bolt receiver having opposing ends with one end attached to said rear of said spool housing and said opposing end inserted through said bolt hole in said brake plate; and
a bolt having opposing ends with one end inserted through said bolt hole in said spool housing cover and threadedly inserted into said bolt receiver.

14. The personal fire escape system as defined in claim 10, wherein said enclosure is about 8 inches high, 8 inches wide, and 2 inches deep.

15. The personal fire escape system as defined in claim 11, wherein said cover, said enclosure, and said spool housing are selected from the group consisting of plastic, steel, aluminum, titanium, wood, and carbon fiber composite.

16. The personal fire escape system as defined in claim 10, wherein said wrist strap is made of nylon.

17. The personal fire escape system as defined in claim 13, wherein said spring urges said brake plate and said brake pad against said spool when said brake lever is not depressed toward said spool housing.

18. In combination with a building, including a window having a bottom and opposing sides, the improvement which comprises:
a hollow enclosure having opposing sides and opposing ends with at least one of said sides and at least one of said ends attached by a wall mount and a window mount and a plurality of screws to at least one of said sides of said window;
an enclosure hook having opposing ends with one end attached to one of said ends of said enclosure;
a housing hook having opposing ends with one end removably connected to said opposing end of said enclosure hook;
a hollow spool housing having a top, a bottom, and a sidewall with said top attached to said opposing end of said housing hook;
a cable having opposing ends with one end connected to said building;
a pulley connected to said cable;
a spool attached to said opposing end of said cable;
an axle having opposing ends and a middle, wherein said spool is mounted on said middle of said axle;
a brake releasably frictionally engaged with said spool, wherein said brake can be adjusted to vary the speed of descent by a user while descending;
a handle attached to said bottom of said spool housing;
a brake lever having opposing ends with one end pivotably attached to said bottom of said spool housing;
a plurality of wrist straps having opposing ends with one end attached to said sidewall of said spool housing;
a cover removably covering said enclosure, wherein said cover is hingedly attached to said enclosure and releasably secured by a latch inserted into a latch receiver;
a plurality of wrist loops attached to said opposing end of said wrist straps; and
a brake rod having opposing ends with one end connected to said brake and said opposing end attached to said end of said brake lever.

19. The improvement to a building as defined in claim 18, wherein said brake comprises:
a spool housing cover attached to said front of said spool housing;
a plurality of bolt holes, wherein said spool housing defines a plurality of holes therein to comprise said bolt holes;
a plurality of spring post holes, wherein said spool housing cover defines a plurality of holes therein to comprise said spring post holes;
a plurality of brake cylinder grooves, wherein said spool housing cover and said rear of said spool housing define grooves therein to comprise said brake cylinder grooves;
a plurality of brake cylinders having opposing ends and a middle inserted into said brake cylinder grooves in said spool housing cover and said spool housing;
a plurality of brake loops, each attaching one end of one of said brake cylinders to said brake rod;
a plurality of brake plate grooves, wherein said middle of said brake cylinders defines a groove therein to comprise said brake plate grooves;
a brake plate inserted into said brake plate grooves;
a plurality of spring post holes, wherein said brake plate defines a plurality of holes therein to comprise said spring post holes;
a plurality of bolt holes, wherein said brake plate defines a plurality of holes therein to comprise said bolt holes;
an axle hole, wherein said brake plate defines a hole therein to comprise said axle hole;
a spool groove, wherein said brake plate defines a groove therein to comprise said spool groove;
a plurality of spring posts having opposing ends with one end inserted through said spring post holes in said brake plate and said spool housing cover;
a plurality of brake pads, wherein each of said brake pads is attached to said opposing end of two of said spring posts;
a plurality of springs, each encircling one of said spring posts between said brake plate and said brake pad;
a plurality of springs, each encircling one of said spring posts between said brake plate and said spool housing cover;
a plurality of bolt receivers, each having opposing ends with one end attached to said rear of said spool housing and said opposing end inserted through one of said bolt holes in said brake plate; and
a plurality of bolts, each having opposing ends with one end inserted through one of said bolt holes in said spool housing cover and threadedly inserted into one of said bolt receivers.

20. The improvement to a building as defined in claim 19, wherein said springs urge said brake plate and said brake pads against said spool when said brake lever is not depressed toward said spool housing.
